(19) United States
(12) Patent Application Publication
(10) Pub. No.: US 2007/0153024 A1
(43) Pub. Date: Jul. 5, 2007

(54) Multi-mode pixelated displays

(75) Inventor: Ian Miller, Lake Forest, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/321,096

(22) Filed: Dec. 29, 2005

(51) Int. Cl. G09G 5/00

(52) U.S. Cl. 345/660

(57) ABSTRACT

A method and system that allow two or more pixel format modes to be displayed on a pixelated display (e.g., PDP, LCD, etc.) to provide optimal display for different applications without the artifacts that are often generated by conventional scaling.

### FIELD OF THE INVENTION

The present invention relates in general to displaying video image information, and in particular to multi-mode display of video image information.

### BACKGROUND OF THE INVENTION

With the advancement of digital imaging technology, the resolution (pixel density) of digital images is increasing continuously. Though research indicates that the human eye can discern up to about 200 pixels per square inch at a typical viewing distance of around 18 inches, many conventional display systems are optimized to only display images up to about 80 to 90 pixels per square inch (native format).

When a desired image pixel format is different from the native pixel format of a pixelated display, then conventionally three display techniques are used. If the desired image format is smaller than the native format of the display, then the image is displayed without modification using part of the image area of the display. However, a disadvantage of this technique is that parts of the display area are blank (usually black), which is often objectionable to users. The blank areas can be substantial parts of the display depending on the formats involved.

If the desired format is larger than the native format of the display, then only a portion of the image may be displayed and the user is required to scroll the image horizontally and/or vertically to access other areas of the image. This constitutes poor ergonomics and is usually frustrating for users.

If the desired format is larger than the native format of the display and it is desired to see the full image or a smaller native format is required to completely fill the available image area, then the input image is scaled for display. However, a disadvantage of this technique is that the scaling process often generates content dependent image artifacts. For many applications such as medical imaging, satellite imaging, etc., introduction of artifacts into image details can lead to severe consequences in image analysis.

### BRIEF SUMMARY OF THE INVENTION

In one embodiment the present invention provides a method and system that allow two or more pixel format modes to be displayed on a pixelated display (e.g., PDP, LCD, etc.) to provide optimal display for different applications without the artifacts that are often generated by conventional scaling.

As such, in one implementation, the present invention provides a method of displaying a pixelated input image on a display device having a native resolution mode, comprising the steps of: selecting a mapping of the input image into a display image based on the pixel resolution of the input image and the native resolution of the display device, wherein the mapping provides a desired display image pixel format for display on the display device; and displaying the display image on the display device.

The step of selecting a mapping can further include the steps of selecting a mapping of the input image into a display image based on the pixel resolution of the input image and the native resolution of the display device, wherein the mapping provides a display image pixel format that is essentially optimized for display on the display device.

Further, the step of selecting a mapping can further include the steps of selecting a 1:n mapping wherein an input image pixel is mapped into n display image pixels, wherein n is a positive integer, wherein in one case the mapping comprises replicating an input image pixel into n display image pixels. In another case, the mapping includes the steps of interpolating an input image pixel into n display image pixels.

The value n can be selected based on the pixel resolution of the input image and the native resolution of the display device, wherein n=1 when the pixel resolution of the input image equals the native resolution of the display device, and n>1 when the pixel resolution of the input image is less than the native resolution of the display device.

The display method can further include the steps of providing multiple mappings for multiple areas of the display device, wherein at least two of the mappings are at different image pixel formats.

In another embodiment, the present invention provides a display system that implements the method of the present invention.

These and other features, aspects and advantages of the present invention will become understood with reference to the following description, appended claims and accompanying figures.

### BRIEF DESCRIPTION OF THE DRAWINGS

FIG. 1 shows an example block diagram of a display system including which implements an embodiment of the present invention.

FIG. 2 shows a flowchart of an example operation of a mapper according to an embodiment of the present invention.

FIG. 3 shows an example block diagram of another display system according to another embodiment of the present invention.

FIGS. 4A-B, show examples of 1:1 mapping and 1:n mapping (e.g., n=4), respectively, according to the present invention.

### DETAILED DESCRIPTION OF THE INVENTION

In one embodiment the present invention provides a method and system that allow two or more pixel format modes to be displayed on a pixelated display (e.g., PDP, LCD, etc) to provide optimal display for different applications without the artifacts that are often generated by conventional scaling.

As such, in one implementation according to the present invention, in case of a display device having a high resolution (native) pixel mode, in the native resolution mode each pixel of a high resolution image source is treated individually and, preferably, mapped directly with a single image pixel from the image source (i.e., 1-to-1 mapping). In the standard resolution mode, each pixel from the image source is mapped to multiple display pixels. When the image source is lower than the resolution of the display device, then a 1-to-n mapping is used, wherein n is an integer greater than 0.

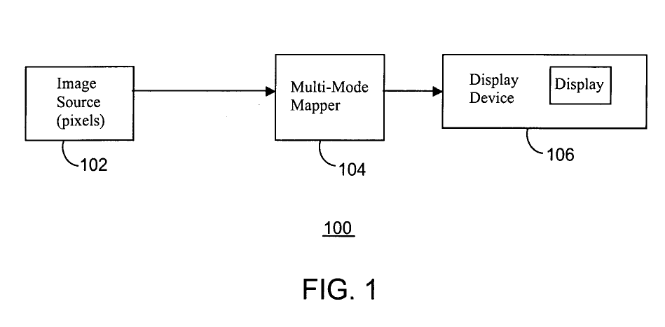

FIG. 1 shows an example block diagram of a system 100 including an image source 102, a mapper 104 that implements an embodiment of the present invention, and a display device 106. The display device 106 can be e.g. a 26″ display with a native pixel format of 3840×2160 pixels (an 8.3 megapixel display), wherein the mapped high resolution mode is 3840×2160 pixels at 170 pixels/inch, and the mapped standard resolution mode is 1920×1080 pixels at 85 pixels/inch.

Using the mapper 104: (1) the high resolution pixel format mode is selected to display high resolution images such as photographic images, graphic output of numerical computer analysis (e.g., complex finite element analysis of complex problems), etc., and (2) the lower resolution format mode is selected to display lower resolution images such as office computer applications (e.g., to write a report about the analysis of the graphical data just viewed), wherein n=4 such that each input image pixel is mapped to a 2×2 block of physical pixels on the display, thereby reducing the effective resolution of the display to ¼ of the high resolution mode and displaying an image with a higher quality. Using the correct selection of the display image size, the lower resolution format mode can be well suited to the display of standard fonts (e.g., designed for around 86 pixels/inch displays) which provides a comfortable user interface.

In addition to the above example, other implementations of a mapper according to the present invention can be utilized. The above example was for professional computer applications, but other formats can be equally applicable to a combination of HDTV (standard resolution mode) and digital camera images (high resolution mode).

When applied to a home entertainment product, another example of the display 106 can be a 46″ display with a native pixel format of 3840×2160 pixels, wherein the high resolution mode is 3840×2160 pixels at 96 pixels/inch, and the low resolution mode is 1920×1080 pixels at 48 pixels/inch. The mapper 104 is implemented such that: (1) the high resolution pixel format mode is selected to display high resolution images such as digital camera images and (2) the lower resolution format mode is selected to display HDTV images, wherein each input image pixel is mapped to a 2=2 block of physical pixels on the display, thereby reducing the effective resolution of the display to ¼ of the high resolution mode and displaying an image with a higher quality.

The standard resolution mode above is simply an example and does not require a 1:4 pixel mapping (i.e., 1 image pixel replicated to n=4 display pixels). Other mapping schemes are possible including displays with several different mappings optimized for different applications and/or usage models. As such, in the general case, the mapper 104 provides multiple modes including native format mode, and 1-to-n (i.e., 1:n) format mapping modes.

In the 1:n format mapping modes, each input image pixel is mapped to a n pixel square area. The 1:n mapping can be performed in many ways, such as by replication of the input image pixel n times. In another version, rather than replicating image pixels on several display pixels in the standard mode, additional display pixels may be generated by interpolation between adjacent image pixels. Other example of pixel generation are possible.

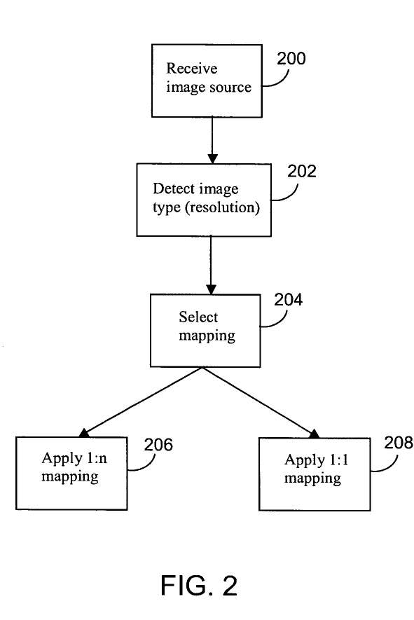

Referring to the example flowchart in FIG. 2, an example operation of another embodiment of the mapper 104 which maps the signal source onto the display includes the steps of:
Step 200: receiving an input image source.
Step 202: detecting the type (e.g., resolution) of input source (e.g., by analyzing the input signal (e.g., TV images move a lot, computer images are mostly static, etc.), or by analyzing the interface type (e.g., TV, VGA, etc.), etc.).
Step 204: selecting the mapping needed (i.e., n=1 when the pixel resolution of the input image equals the native resolution of the display device, and n>1 when the pixel resolution of the input image is less than the native resolution of the display device).
Step 206: if an image is of lower resolution than the native resolution of the display device, then in a 1:n mode if the source image resolution is an integer multiple of the native resolution, then the image is displayed by replicating each input pixel multiple times (e.g., HDTV signal pixel is replicated multiple times) or by inter-pixel interpolation, to generate and display an image that is of higher image quality than conventional.
Step 208: if the input image is of high resolution then the mapper displays the image in the native mode of the display device without pixel replication or interpolation.

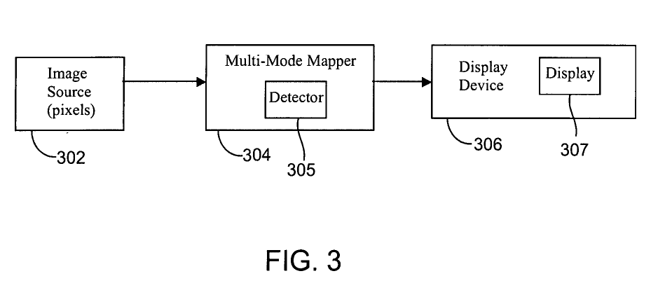

FIG. 3 shows a block diagram of a system 300 according to an embodiment of the present invention, example including an image source 302, a mapper 304 that implements an embodiment of the present invention, and a display device 306. The mapper 304 includes a detector 305 that implements step 202 of FIG. 2 to automatically detect input image source resolution, enabling the mapper 304 to automatically select the display mode to optimize display of the input image on the display 307 by the display device 306.

In another embodiment of the present invention, the mapper 304 provides a picture-in-picture and/or picture-by-picture capability wherein the mapper maps input images onto two or more sub-areas of the display at different resolution format modes. As such, each sub-area of the display can have a different value of n associated therewith for mapping.

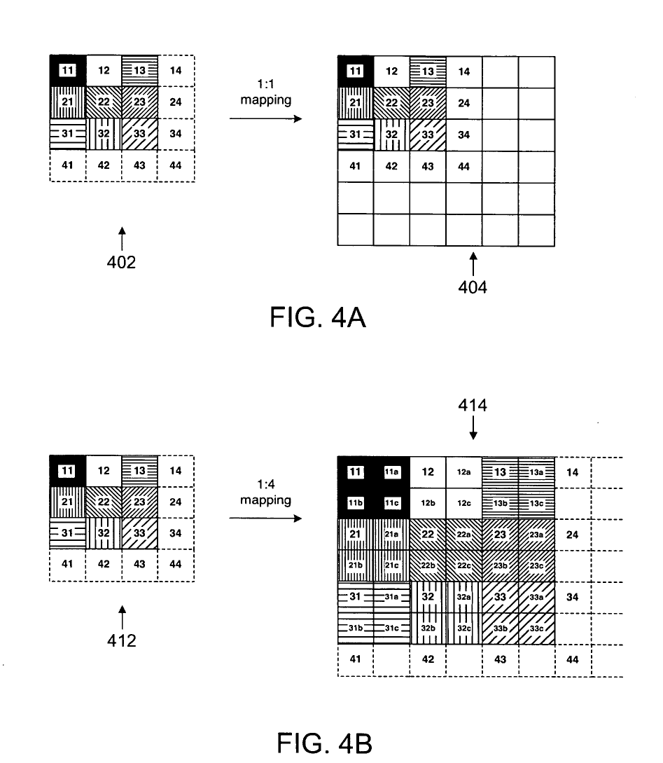

Referring to the example in FIGS. 4A-B, examples of 1:1 mapping and 1:n mapping (e.g., n=4), respectively, are shown. In FIG. 4A, the left hand block 402 represents the pixels (4×4) of the input image. The right hand block 404 represents a portion of the native pixel format of the output display. In 1:1 mapping (FIG. 4A) there is a direct correspondence between an input pixel and an output display pixel.

In FIG. 4B, the left hand block 412 represents the pixels (4×4) of the input image. The right hand block 414 represents a portion of the native pixel format of the output display. In the example 1:4 mapping (FIG. 4B) there is a direct correspondence between each input pixel and one quarter of the output display pixels—those marked 11, 12, 13, 21, 22, 23, etc. However, the output display pixels identified, for example, as 12a, 12b and 12c may either be a duplicate of pixel marked 11 or be a value generated by interpolation between adjacent pixels.

Various interpolation algorithms exist and may be used but for illustration purposes one of the simplest is used here:

Pixel 12a is midway between pixels 12 and 13 (luminance and color).
Pixel 12b is midway between pixels 12 and 22 (luminance and color).
Pixel 12c is midway between pixels 12 and 23 (luminance and color).
The above is repeated for other pixels.

Therefore, the present invention provides a mapper that allows display of images in two or more display modes, wherein based on the image resolution the mapper selects a display mode that enables the display device to fill the full display area. Accordingly, different display modes may be optimized as is desired by users. In particular if the user has a high resolution mode application (e.g., image analysis, viewing of digital photographs, etc) and a more modest resolution application (e.g., computer office tasks, television viewing, etc.) then these apparently contradictory applications can both be optimally displayed on the same display, eliminating the need for scaling or multiple display devices.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of displaying a pixelated input image on a display device having a native resolution mode, comprising the steps of:
selecting a mapping of the input image into a display image based on the pixel resolution of the input image and the native resolution of the display device, wherein the mapping provides a desired display image pixel format for display on the display device; and
displaying the display image on the display device.

2. The method of claim 1, wherein the step of selecting a mapping further includes the steps of selecting a mapping of the input image into a display image based on the pixel resolution of the input image and the native resolution of the display device, wherein the mapping provides a display image pixel format that is essentially optimized for display on the display device.

3. The method of claim 1, wherein the step of selecting a mapping further includes the steps of selecting a 1:n mapping wherein an input image pixel is mapped into n display image pixels, wherein n is a positive integer.

4. The method of claim 3, wherein the step of mapping includes the steps of replicating an input image pixel into n display image pixels.

5. The method of claim 3, wherein the step of mapping includes the steps of interpolating an input image pixel into n display image pixels.

6. The method of claim 5, wherein the step of interpolating further includes the steps of interpolating between adjacent image pixels.

7. The method of claim 3 wherein n is selected based on the pixel resolution of the input image and the native resolution of the display device.

8. The method of claim 7 wherein n=1 when the pixel resolution of the input image equals the native resolution of the display device.

9. The method of claim 7 wherein n>1 when the pixel resolution of the input image is less than the native resolution of the display device.

10. The method of claim 1 further comprising the steps of providing multiple mappings for multiple areas of the display device.

11. The method of claim 10 wherein at least two of the mappings are at different image pixel formats.

12. The method of claim 1 further comprising the steps of determining the pixel resolution of the input image.

13. A display system for displaying a pixelated input image from an input image source, comprising:
a display device having a native resolution mode; and
a mapper that selects a mapping of the input image into a display image based on the pixel resolution of the input image and the native resolution of the display device, wherein the mapping provides a desired display image pixel format for display on the display device.

14. The system of claim 13, wherein the mapper selects a mapping of the input image into a display image based on the pixel resolution of the input image and the native resolution of the display device, wherein the mapping provides a display image pixel format that is essentially optimized for display on the display device.

15. The system of claim 13, wherein the mapper selects a 1:n mapping wherein an input image pixel is mapped into n display image pixels, wherein n is a positive integer.

16. The system of claim 15, wherein the mapper replicates an input image pixel into n display image pixels.

17. The system of claim 15, wherein the mapper interpolates an input image pixel into n display image pixels.

18. The system of claim 17, wherein the mapper interpolates between adjacent image pixels.

19. The system of claim 15 wherein n is selected based on the pixel resolution of the input image and the native resolution of the display device.

20. The system of claim 19 wherein n=1 when the pixel resolution of the input image equals the native resolution of the display device.

21. The system of claim 19 wherein n>1 when the pixel resolution of the input image is less than the native resolution of the display device.

22. The system of claim 13 wherein the mapper provides multiple mappings for multiple areas of the display device.

23. The system of claim 22 wherein at least two of the mappings are at different image pixel formats.
